(19) United States
(12) Patent Application Publication
(10) Pub. No.: US 2017/0229957 A1
(43) Pub. Date: Aug. 10, 2017

(54) THD IN OFF-LINE CONVERTERS

(71) Applicant: SEMICONDUCTOR COMPONENTS INDUSTRIES, LLC, Phoenix, AZ (US)

(72) Inventors: Henry Frazier PRUETT, North Bend, OR (US); Armando Gabriel MESA, Tempe, AZ (US)

(73) Assignee: SEMICONDUCTOR COMPONENTS INDUSTRIES, LLC, Phoenix, AZ (US)

(21) Appl. No.: 15/161,422

(22) Filed: May 23, 2016

Related U.S. Application Data
(60) Provisional application No. 62/291,841, filed on Feb. 5, 2016.

(51) Int. Cl. H02M 3/08; H02M 1/12; H02M 1/42; H02M 1/08

(52) U.S. Cl. CPC H02M 3/08; H02M 1/08; H02M 1/12; H02M 1/42

(57) ABSTRACT

A switched mode power supply (SMPS) receives an input voltage selectively connects and disconnects the input voltage from an inductor. The SMPS generates a charge in the inductor during a duty cycle portion while the input voltage is connected by generating control signals for selectively connecting to and disconnecting the input voltage from the inductor. Generating the control signals includes modulating a current source for a control capacitive element, selectively shorting the control capacitive element wherein a voltage V_{CT} appears across the capacitive element when control capacitive element is not being shorted, and comparing voltage V_{CT} to a threshold voltage generate an inverted DRIVE SIGNAL to selectively short the control capacitive element.

### CROSS-REFERENCE TO RELATED APPLICATION(S)

This application claims priority to U.S. Provisional Application No. 62/291,841, filed on Feb. 5, 2016, entitled “Improved THD In Off-Line Converters,” invented by Frazier Pruett and Armando Mesa, and is incorporated herein by reference and priority thereto for common subject matter is hereby claimed.

### FIELD OF THE DISCLOSURE

The present disclosure relates generally to biasing circuits and, more particularly, to reference current sources.

### BACKGROUND

Peak current control or on time control are common forms of primary power control because the peak current in the power control switch is naturally proportional to the input voltage. One advantage is that peak current and/or time power levels (current and/or voltage) are easy to measure and control. Typically, a line current is related to a line voltage. While the current is related to the voltage, however, it is not linearly proportional because there are factors in the transfer function that are not linear over the line cycle. This lack of linearity is a source of distortion. The distortion can be acceptable within a certain operating range but is not generally acceptable.

Minimizing current harmonics due to distortion is a regulatory requirement customers face in the development of off-line switch-mode power supplies (SMPS). In North America regulatory agencies impose a maximum Total Harmonic Distortion (THD) that the SMPS can generate. The European Union is governed by EN61000-3-2 that imposes limits on the exported line current spectrum. These two sets of requirements address the generation of line current harmonics caused by non-linear loading that the SMPS imposes on the AC mains.

High power SMPS utilize closed loop control of the line current to correct distortion at the expense of added cost, size, and complexity. This control methodology is mostly exclusive to the boost converter topology. The recent proliferation of low power, low cost applications, necessitates the development of cost effective control methodologies and techniques that can address the various harmonic standards and be utilized with multiple converter topologies. Drivers used in low cost applications, in particular, often use simple, non-isolated SMPS topologies to minimize system cost. These systems can not afford to employ the traditional harmonic correction techniques used by high power SMPS because of costs in terms of circuit, power consumption, or even actual cost because they are being used in low cost applications. What is needed, therefore, is a simpler and low cost system and method for reducing harmonics that may be used in low cost applications.

### BRIEF DESCRIPTION OF THE DRAWINGS

The present disclosure may be better understood, and its numerous features and advantages made apparent to those skilled in the art by referencing the accompanying drawings, in which:

FIG. 1 is a schematic diagram of a prior art CTON generator.

FIG. 2 is a signal diagram that illustrates a current response curve I_{CT} for the CTON generator of FIG. 1 for a current conducted through the timing capacitor.

FIG. 3 is a partial schematic and partial block diagram of a Buck Boost SMPS with a controller according to one embodiment.

FIG. 4 is a signal flow diagram that illustrates a current IL through an inductor of an SMPS according to one embodiment.

FIG. 5 is a schematic diagram of a CTON generator of a controller according to one embodiment.

FIG. 6 is a set of three signal diagrams that illustrate operation according to one embodiment.

FIG. 7 is a flow chart that illustrates a method for a switched mode power supply (SMPS) according to one embodiment.

The use of the same reference symbols in different drawings indicates similar or identical items. Unless otherwise noted, the word “coupled” and its associated verb forms include both direct connection and indirect electrical connection by means known in the art, and unless otherwise noted any description of direct connection implies alternate embodiments using suitable forms of indirect electrical connection as well.

### DETAILED DESCRIPTION

A traditional constant on-time (CTON) control architecture is low-cost and easy to implement and can be utilized with various power factor correction (PFC) converter topologies such as boost, flyback, buck & buck-boost topologies. A limitation of this CTON architecture is that performance is dependent on the topology. For example, the minimum achievable total harmonic distortion (THD) performance in the buck converter is 13% and is dependent on output voltage. While good THD could be achieved in for some designs and topologies, a CTON control architecture does not meet THD performance requirements for other topologies. Thus, some devices have employed an “open loop” reference signal intended to shape the input current waveform. The THD performance with a triangular reference signal looks comparable, if not only slightly worse, than expected performance with CTON. Operating ranges in topologies like buck converters are limited, however. Many devices employ a multiplier and/or closed loop control of the input current. Multipliers, however, require a large silicon die area and external components for sensing & filtering of the line voltage and thus are not appropriate solutions in many instances.

FIG. 1 is a schematic diagram of a prior art CTON generator. A controller 10 includes a current source 12 that produces a current I_{CT} to a timing capacitor (C_{T}) 14. A switch 16 is connected across capacitor 14. Switch 16 is a selectable switch and closes upon receiving an inverted drive signal (DRV). A node that connects current source 12 to capacitor 14 and switch 16 is also connected to a first input of a comparator 20 to receive V_{CT}. A second input of comparator 20 is connected to receive a threshold or comparison voltage for comparison with V_{CT}. An output of comparator 20 generates the inverted drive signal that drives switch 16.

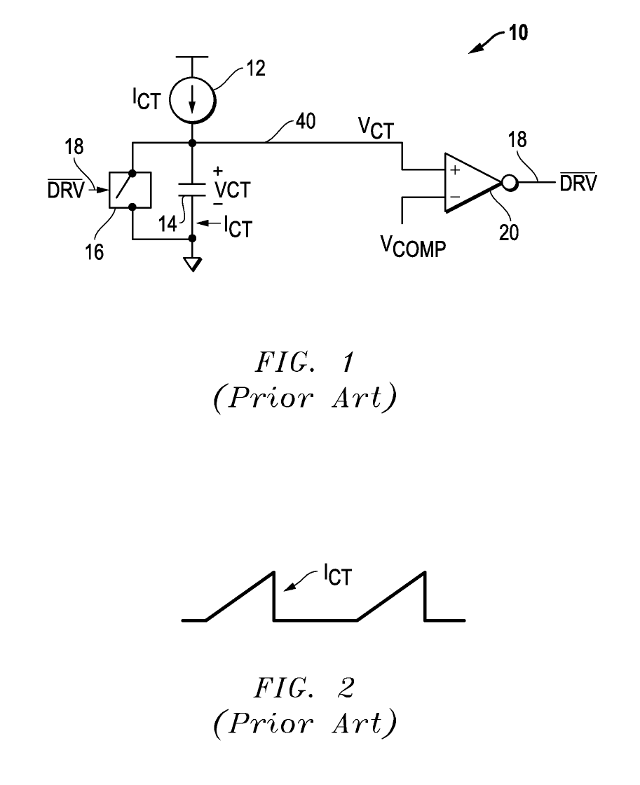

FIG. 2 is a signal diagram that illustrates a current response curve I_{CT} for the CTON generator of FIG. 1 for a current conducted through the timing capacitor. As may be seen, the current response curve has an alternating pattern in which a saw tooth pattern of a fixed period alternates with a flat line response curve representing no current for an equal fixed period. The inventors have realized that this pattern may contribute to unacceptably high harmonic distortion on the output signal.

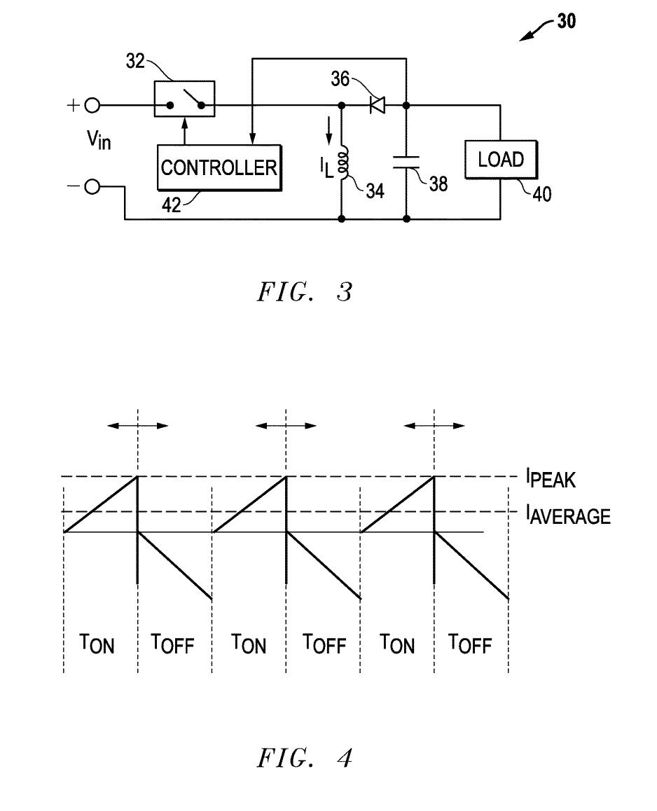

FIG. 3 is a partial schematic and partial block diagram of a Buck Boost SMPS with a controller according to one embodiment. An input terminal is connected to receive an input voltage that is to be increased by a Buck Boost SMPS 30 of FIG. 3. A switch 32 is connected to the input terminal to receive an input signal as well as to an inductor 34 and to a cathode terminal of diode 36. An anode terminal of diode 36 is connected to a capacitor 38 and a load 40. Second ends of inductor 34, capacitor 38 and load 40 are connected to circuit common or ground as is the “minus” input terminal. Additionally, a controller 42 is connected to produce a drive signal to switch 32 to drive the output voltage based upon an output voltage.

In operation, controller 42 generates a drive signal to selectively open and close switch 32 causing the input voltage to selectively appear across inductor 34. Inductor 34 generates a field as a current IL is conducted through its coils. When switch 32 opens, inductor 34 discharges and conducts through capacitor 38 to create a voltage output across load 40. The relative open and close period lengths and the frequency of switching are factors in a magnitude of the output voltage appearing across load 40.

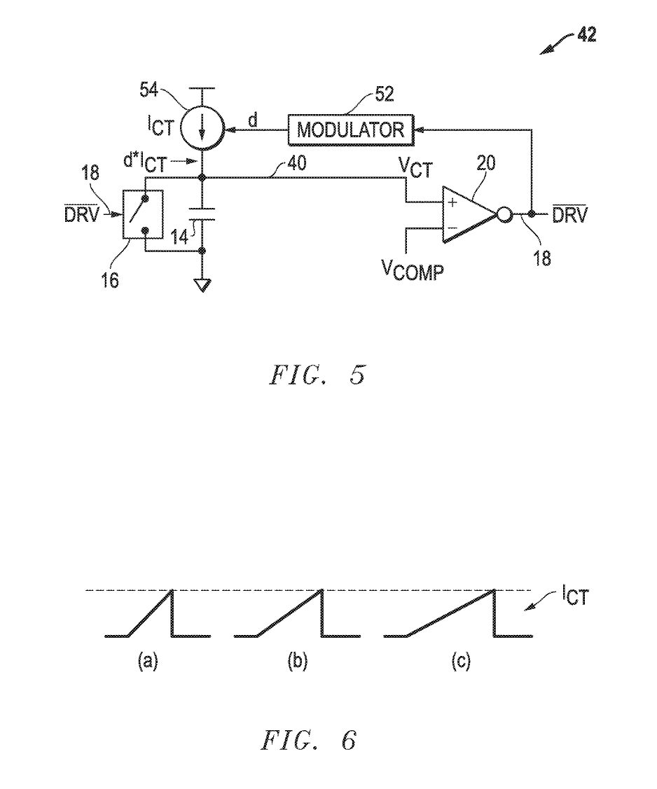

FIG. 4 is a signal flow diagram that illustrates a current IL through an inductor of an SMPS according to one embodiment. As may be seen, the signal flow illustrates alternating saw tooth patters during an ON period T_{ON} and during an OFF period T_{OFF}. One aspect of the embodiments disclosed herein is that the period for T_{ON} is adjustable and may be modulated in a manner that reduces harmonic distortion. As may be seen in FIG. 4, the transition point from ON period T_{ON} and OFF period T_{OFF} may be shortened or increased. The above-disclosed subject matter is to be considered illustrative, and not restrictive, and the appended claims are intended to cover all such modifications, enhancements, and other embodiments that fall within the true scope of the claims

FIG. 5 is a schematic diagram of a CTON generator of a controller according to one embodiment. A controller 30 includes a modulator 32 that produces a control signal “d” to current source 34 that produces a current d*I_{CT} to a timing capacitor 14 (C_{T}). Switch 16 is connected across capacitor 14. Switch 16 is a selectable switch and closes upon receiving an inverted of a drive signal (DRV). A node that connects current source 34 to capacitor 14 and switch 16 is also connected to a first input of a comparator 20. A second input of comparator 20 is connected to receive a threshold or comparison voltage. An output of comparator 20 generates the inverted drive signal that drives switch 16. Modulator 32 is further connected to receive the inverted drive signal and is operable to determine a modulation factor. The control signal “d” produced by modulator 32 serves to short or extend the current magnitude of current source 34 to increase or decrease the charge period of the timing capacitor 14. By extending the charge period when timing constraints allow, THD of the output signal is reduced.

The circuit of FIG. 5 reduces THD by adjusting a duty cycle of the charge time of the timing capacitor to correspond with a sinusoidal input voltage. To clarify, an average input current is given by:

$$\begin{matrix}{I}_{AVG} = \frac{{I}_{PEAK}}{2} * d & ( A ) \\ {I}_{PEAK} = \frac{{V}_{IN} * {T}_{ON}}{L} = \frac{k sin ( ω t ) * {T}_{ON}}{L} & ( B ) \\ By substituting for {I}_{PEAK} & \\ {I}_{AVG} = \frac{k sin ( ω t ) * {T}_{ON} * d}{2 L} & ( C )\end{matrix}$$

As may be seen, the duty cycle, d, shows up as a multiplication factor in the average input current. The duty cycle is not constant but varies with respect to the line voltage. Consequently, the duty cycle becomes a source of distortion preventing the average input current from being directly proportional to sin(ωt).

While duty cycle typically refers to the on time of the switching element divided by the period, it is also a scalar between 0 and 1. If switching element is on for 1 part out of 10, the duty cycle is 10%. In an average representation of a switching converter, we represent duty cycle in this way rather than the “on time÷period” way. Here, “d” is treated as a scalar representation of the actual “on time÷period” to modulate the current source which is charging the timing capacitor. The current source is not turned on/off with the switching element but rather is modulated by the scalar value of d.

The value of d is completely dependent on the input and output voltages. The exact equation depends on the type of converter (i.e. buck, buck-boost, etc.). The controller calculates the value of d based on the input and output voltages or some linear representation of those voltages. It may not be convenient to measure input and output voltage directly.

For the buck-boost, flyback, and SEPIC topologies, for example, duty is as follows:

$$\begin{matrix}\frac{{V}_{out}}{{V}_{i n}} = \frac{d}{( 1 - d )} & ( D ) \\ accordingly , & \\ d = \frac{{V}_{out}}{( {V}_{i n} + {V}_{out} )} & ( E )\end{matrix}$$

Because a scaled presentation of Vin and Vout can be measured, the duty cycle can be calculated.

Referring back to FIG. 1, which is a simplified prior art CTON generator. A current source, I_{CT}, charges a timing capacitor, CT, and the voltage on the capacitor is compared against a threshold set by the compensation voltage, V_{COMP}. The on-time is determined by the capacitor state equation where ΔV is V_{COMP}. V_{COMP}, being a low bandwidth signal, remains relatively constant over the duration of a line cycle forcing T_{ON} to do the same. Accordingly,

$$\begin{matrix}Δ T = \frac{C * Δ V}{I} & ( D ) \\ {T}_{ON} = \frac{{C}_{T} * {V}_{COMP}}{{I}_{CT}} & ( E )\end{matrix}$$

By combining (E) into (C), we get:

$${I}_{AVG} = \frac{k sin ( ω t ) * {C}_{T} * {V}_{COMP} * d}{2 L * {I}_{CT}} \qquad ( F )$$

As previously stated, the duty cycle multiplier “d” in the equation causes distortion since the average input current is no longer proportional to the sinusoidal input voltage. The duty cycle multiplier may be eliminated by estimating the duty cycle for a subsequent switching cycle and then modulating the charge current by the estimated duty cycle. In this manner I_{CT} is also variable with respect to the duty cycle thereby cancelling the duty cycle multiplier and fixing the average input current to be proportional to sin(ωt) which therefore reduces or eliminates THD.

Referring back to FIG. 5, therefore, modulator 32 evaluates duty cycles by receiving the inverted drive signal to estimate a subsequent duty cycle. Accordingly, modulator 32 produces control signal “d” to current source 34 to reduce or increase the current level as necessary to have a charge time of the timing capacitor TC match the duty cycle of the input signal.

As such, the described embodiments generally contemplate a switched mode power supply (SMPS) that includes an input connected to receive a voltage and a switch connected to the input to selectively connect and disconnect the input voltage. An inductor is connected to the switch to conduct current and generate a charge while the switch is closed and the input voltage is connected. A controller is configured to generate control signals to open and close the switch. The controller, in order to improve THD, includes a modulated current source, a capacitive element in series with the modulated current source, and a selectable switch coupled across the capacitive element wherein a voltage V_{CT} appears across the capacitive element when the switch is open due to the current from the modulated current source flowing through the capacitive element. A comparator coupled to receive voltage V_{CT} and a reference voltage generates an inverted DRIVE signal to drive the switch coupled across the timing capacitor.

The inverted DRIVE signal is, essentially, a reset signal that shorts the timing capacitor to discharge it and reset the system whenever the received voltage V_{CT} is greater than or equal to the threshold voltage. The controller also includes a modulator that estimates subsequent duty cycle periods and modulates the current I_{CT} so that the charge time of the timing capacitor matches the expected duty cycle period. The more the charge time matches the subsequent duty cycle period, the lower THD will be. One aspect of the embodiment of FIG. 5 is that the modulated current source is modulated to drive a current characterized by a percentage of a maximum current value that corresponds to a duty cycle of the current signal that flows through the inductor. Accordingly, the modulated current source is modulated so as to charge the capacitive element approximately to correspond with an “ON” portion of a duty cycle of the current signal that flows through the inductor.

A switched mode power supply may include, therefore, an inductor, a switch configured to selectively energize the inductor with an input signal, and a control circuit connected to deliver a control signal to selectively open and close the switch wherein the control circuit is configured to modulate an on time that the switch is closed based upon an expected duty cycle of the control signal. In one embodiment, the on time is modulated inversely to an expected operating duty cycle of the switch. Alternatively, the on time is modulated inversely to an expected operating duty cycle of the switch multiplied by (1−d). The duty cycle for a subsequent switching period may be an estimated duty cycle that is based on, for example, for a subsequent switching period, on a measurement of a previous duty cycle or on a continuously running average measurement of previous duty cycles.

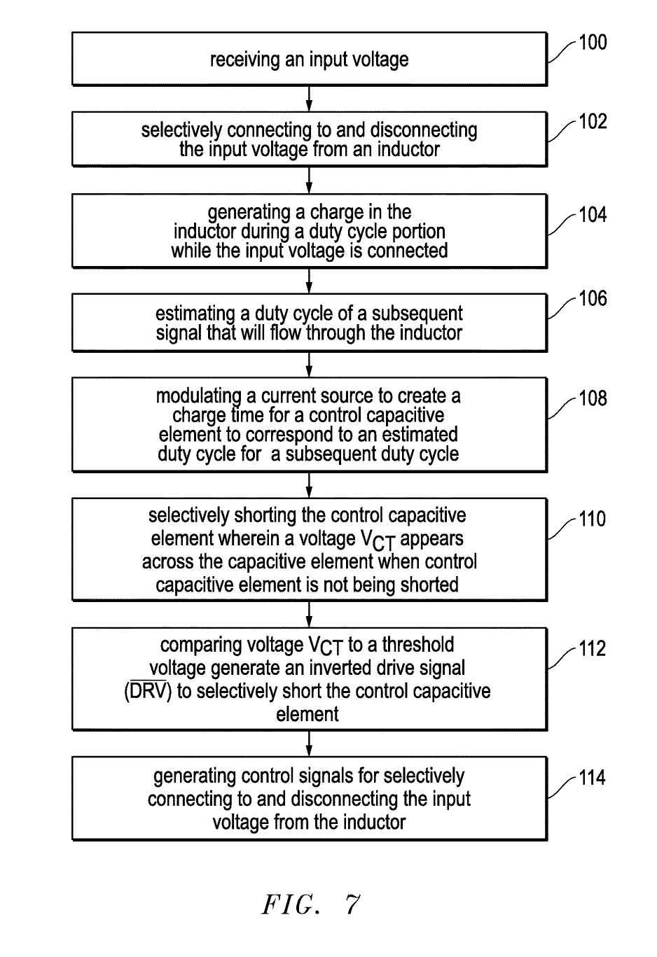

FIG. 6 is a set of three signal diagrams that illustrate operation according to one embodiment. Referring to 6(a), 6(b) and 6(c), one may observe the differing charge periods for the timing capacitor 14.

FIG. 7 is a flow chart that illustrates a method for a switched mode power supply (SMPS) according to one embodiment. The method of FIG. 7 commences with receiving an input voltage (100) and selectively connecting to and disconnecting the input voltage from an inductor (102). Accordingly, the method includes generating a charge in the inductor during a duty cycle portion while the input voltage is connected (104). One aspect of the described embodiment is that a charge time of a timing capacitor is modified to match a duty cycle of the inductor or input signal. Accordingly, the method includes estimating a duty cycle of a subsequent signal that will flow through the inductor (106) and modulating a current source to create a charge time for a control capacitive element to correspond to an estimated duty cycle for a subsequent duty cycle (108). In one embodiment, this method includes modulating the current source to drive a current characterized by a percentage of a maximum current value that corresponds to a duty cycle of the current signal that flows through the inductor. In another embodiment, this method includes modulating the current source so as to charge the capacitive element approximately to correspond with an “ON” portion of a duty cycle of the current signal that flows through the inductor. Additionally, the method includes selectively shorting the control capacitive element wherein a voltage V_{CT} appears across the control capacitive element when control capacitive element is not being shorted (110). This step may include comparing voltage V_{CT} to a threshold voltage generate an inverted DRIVE SIGNAL to selectively short the control capacitive element (112). Finally, the method includes a controller generating control signals for selectively connecting to and disconnecting the input voltage from the inductor (114).

The blocks and circuit elements may be implemented with various combinations of hardware and software, and the software component may be stored in a computer readable storage medium for execution by at least one processor. Moreover the method illustrated in FIG. 7 may also be governed by instructions that are stored in a computer readable storage medium and that are executed by at least one processor. Each of the operations shown in FIG. 7 may correspond to instructions stored in a non-transitory computer memory or computer readable storage medium. In various embodiments, the non-transitory computer readable storage medium includes a magnetic or optical disk storage device, solid state storage devices such as Flash memory, or other non-volatile memory device or devices. The computer readable instructions stored on the non-transitory computer readable storage medium may be in source code, assembly language code, object code, or other instruction format that is interpreted and/or executable by one or more processors.

Thus, to the maximum extent allowed by law, the scope of the present invention is to be determined by the broadest permissible interpretation of the following claims and their equivalents, and shall not be restricted or limited by the foregoing detailed description.

1. A switched mode power supply (SMPS), comprising:
an inductor;
a switch configured to selectively energize the inductor with an input signal; and
a control circuit connected to deliver a control signal to selectively open and close the switch wherein the control circuit is configured to modulate an on time that the switch is closed based upon an expected duty cycle of the control signal.

2. The SMPS of claim 1 wherein the on time is modulated inversely to an expected operating duty cycle of the switch.

3. The SMPS of claim 1 wherein the on time is modulated inversely to an expected operating duty cycle of the switch multiplied by (1−d).

4. The SMPS of claim 1 wherein the control circuit comprises:
a modulated current source;
a capacitive element in series with the modulated current source;
a selectable switch coupled across the capacitive element wherein a voltage V_{CT} appears across the capacitive element when the selectable switch is open due to the current from the modulated current source flowing through the capacitive element; and
a comparator coupled to receive a voltage V_{CT}.

5. The SMPS of claim 4 wherein the comparator is coupled to receive a threshold voltage to compare to the voltage V_{CT}.

6. The SMPS of claim 5 wherein the comparator is configured to produce a reset signal whenever the voltage V_{CT} is greater than or equal to the threshold voltage.

7. The SMPS of claim 4 wherein the modulated current source is modulated to drive a current characterized by a percentage of a maximum current value that corresponds to a duty cycle of a current signal that flows through the inductor.

8. The SMPS of claim 4 wherein the modulated current source is modulated so as to charge the capacitive element approximately to correspond with an on portion of a duty cycle of a current signal that flows through the inductor.

9. The SMPS of claim 4 wherein the modulated current source is modulated to correspond to an estimated duty cycle for a subsequent switching period.

10. The SMPS of claim 4 wherein the modulated current source is modulated to correspond to an estimated duty cycle based on a measurement of a previous duty cycle.

11. The SMPS of claim 4 wherein the modulated current source is modulated to correspond to an estimated duty cycle based on a continuously running average measurement of previous duty cycles.

12. A controller for a switched mode power supply (SMPS), comprising:
a modulated current source;
a capacitive element in series with the modulated current source;
a selectable switch coupled across the capacitive element wherein a voltage V_{CT} appears across the capacitive element when the selectable switch is open due to the current from the modulated current source flowing through the capacitive element; and
a comparator coupled to receive a voltage V_{CT}.

13. The controller of claim 12 wherein the comparator is coupled to receive a threshold voltage to compare to the voltage V_{CT}.

14. The controller of claim 13 wherein the comparator is configured to produce a reset signal whenever the voltage V_{CT} is greater than or equal to the threshold voltage.

15. The controller of claim 12 wherein the modulated current source is modulated to drive a current characterized by a percentage of a maximum current value that corresponds to a duty cycle of a current signal that flows through an inductor of the SMPS.

16. The controller of claim 15 wherein the modulated current source is modulated so as to charge the capacitive element approximately to correspond with an “ON” portion of a duty cycle of the current signal that flows through the inductor.

17. The controller of claim 12 wherein the modulated current source is modulated to correspond to an estimated duty cycle for a subsequent duty cycle of a current signal that flows through an inductor of the SMPS.

18. A method for a switched mode power supply (SMPS), comprising:
receiving an input voltage;
selectively connecting to and disconnecting the input voltage from an inductor;
generating a charge in the inductor during a duty cycle portion while the input voltage is connected; and
generating control signals for selectively connecting to and disconnecting the input voltage from the inductor wherein generating the control signals further includes:
modulating a current source for a control capacitive element;
selectively shorting the control capacitive element wherein a voltage V_{CT} appears across the control capacitive element when the control capacitive element is not being shorted; and
comparing voltage V_{CT} to a threshold voltage generate an inverted drive signal to selectively short the control capacitive element.

19. The method of claim 18 further including producing a reset signal whenever the voltage V_{CT} is greater than or equal to the threshold voltage.

20. The method of claim 18 further including modulating the current source to drive a current characterized by a percentage of a maximum current value that corresponds to a duty cycle of a current signal that flows through the inductor.

21. The method of claim 18 further including modulating the current source so as to charge the control capacitive element approximately to correspond with an on portion of a duty cycle of a current signal that flows through the inductor.

22. The method of claim 18 further including modulating the current source to correspond to an estimated duty cycle for a subsequent duty cycle.

23. The method of claim 18 further including estimating a duty cycle of a subsequent signal that will flow through the inductor.

24. The method of claim 23 further including modulating the current source such that a charge time of the capacitive element substantially matches the estimated duty cycle of the subsequent signal.
